(19) United States
(12) Patent Application Publication
(10) Pub. No.: US 2006/0000533 A1
(43) Pub. Date: Jan. 5, 2006

(54) Tire

(76) Inventor: William Scale Hendrie, Scarborough (CA)

Correspondence Address: William S. Hendrie, 8 Lakeside Ave., Scarborough, M1N 3C1, CA

(21) Appl. No.: 11/157,829

(22) Filed: Jun. 22, 2005

Related U.S. Application Data
(60) Provisional application No. 60/584,162, filed on Jul. 1, 2004.

(51) Int. Cl. B60C 13/02; B60C 13/04; B60C 23/06

(52) U.S. Cl. 152/523; 152/524; 116/34 A

(57) ABSTRACT

Disclosed herein is a pneumatic tire comprising a pair of sidewalls and a ground engaging surface extending therebetween, at least one of the sidewalls bearing two outwardly visible, outwardly projecting, concentric, inflation indicating beads. When the tire is correctly inflated, the section of the concentric inflation indicating beads adjacent to the ground, and vertically below the axle appear to abut each other when viewed from a vertical position above the axle. When the said tire is moderately, incorrectly under-inflated, the aforementioned portions of the tire inflation beads adjacent to the ground, when viewed in the noted manner, will appear separated by a visible interstitial band of sidewall material. Additionally, an arc of the radially outermost bead, adjacent to the ground surface, when viewed in noted manner, will not be visible when the tire is extremely under-inflated.

### SUMMARY OF INVENTION

A pneumatic tire has a pair of sidewalls arid a ground engaging surface extending therebetween. Two outwardly visible, concentric, outwardly projecting, inflation indicator beads cohere to at least one of the said sidewalls. Arcs of the inflation indicator beads are positioned relative to the ground engaging surface and, when the tire is incorrectly under-inflated, the two noted beads appear separated from each other by a section of interstitial sidewall material, when viewed from any angle.

Conversely, when the tire is correctly inflated, the inflation indictor beads are oriented so that portions of beads adjacent to the ground, when viewed from a position vertically above the vehicle axle, appear to abut each other.

In one orientation, the portion of the inflation indicator ring, radially closest to the ground, is concealed or partially concealed by an overlapping section of the sidewall if the tire is extremely under-inflated.

In another embodiment, the present invention provides an automobile comprising a plurality of pneumatic tires as defined herein above.

Other features and advantages of the invention will become apparent to one of ordinary skill in the art upon a review of the following drawings in conjunction with the following description of example embodiments of the invention.

### BRIEF DESCRIPTION OF THE DRAWINGS

In the figures which illustrate example embodiments of the invention,

FIG. 1 is a side view of a tire made in accordance with this invention,

FIG. 2 is a cross-sectional view of the tire (but not the wheel hub) of FIG. 1 along the lines 2-2 of FIG. 1,

FIG. 3 is a partial schematic front view of a properly inflated tire of FIG. 2 showing use-of this invention,

FIG. 4 is a partial schematic front view of a moderately under-inflated tire of FIG. 2 showing use of this invention, and

FIG. 5 is a side view of a tire made in accordance with another embodiment of this invention.

### DETAILED DESCRIPTION

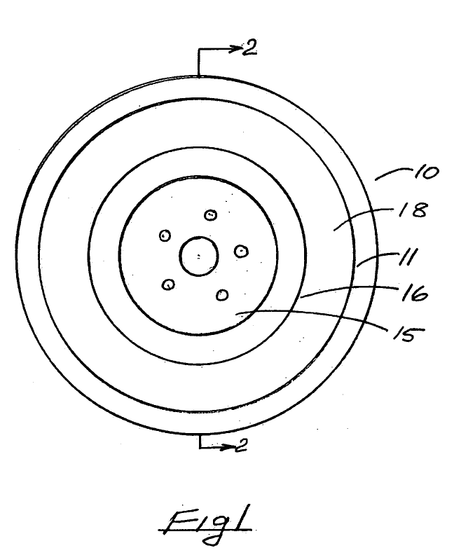

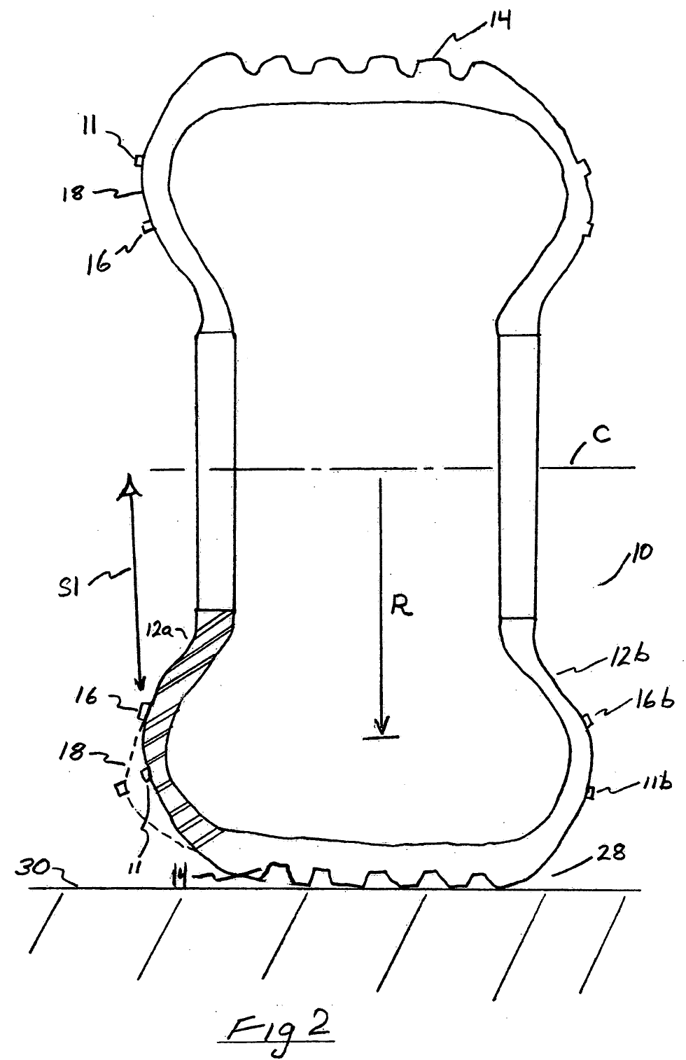

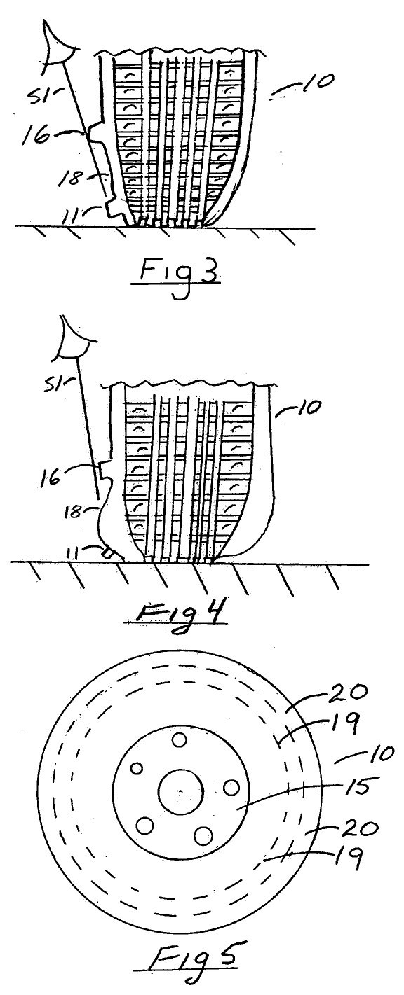

With reference to figures 1 and 2, a tire 10 has a pair of side walls 12a, 12b (collectively, sidewalls 12) with a tread bearing ground engaging surface 14 extending therebetween. Sidewall 12a has an outwardly projecting annular bead 16 and a second outwardly projecting-annular bead 11. Bead 16 is positioned radially inwardly of a radius R at which side wall 12a maximally bulges and bead 11 is positioned radially outwardly of radius R at which side wall 12a maximally bulges. As shown, side wall 12b has similar beads 11b, 16b.

Beads 11, 16 may be concentric with the central axis C of the tire 10. The first bead 16 may have a contrasting colour to that of the second bead. The annular band 18 of the tire between the first bead 16 and the second bead 11 may have a colour which contrasts-with a colour of the first bead and a colour of the second bead. Beads 11 and 16 may be continuous annular beads or they may be formed from a plurality of arcuate bead segments.

Optionally, each bead may have arcs that have different colours. In such instance, a given arc of the first bead should have a contrasting colour to a radially aligned arc of the second bead.

In use, if the tire is correctly inflated, there will be sight lines looking down toward the portion 28 of the tire 10 that engages the ground 30, such as sight line S1, whereat the first and second beads 11, 16 are aligned. In other words, where the first bead 16 visually overlaps the second bead 11. If the tire is mildly under-inflated (as illustrated in phantom in FIG. 1), the band 18 will bulge outwardly such that it becomes impossible to find any sight line whereat the first and second beads 11, 16 are aligned.

Sidewall 12b may have similar beads 11b, 16b so that the tire may be used on the opposite side of a vehicle.

### DETAILED DESCRIPTION

The figures illustrate the present invention and two of its several possible embodiments. Common to all embodiments are a tire (10) and a pair of sidewalls (12). The sidewalls (12) are integrally attached to a ground engaging surface (14) which may be formed with a tread pattern. The vehicle wheel hub (15) facilitates mounting the tire to the vehicle axle and is illustrated in FIG. 1 for clarity purposes only.

In one particular embodiment, two concentric outwardly projecting annular beads, (11,16), are integral to the tire (10). The beads are colored concentric rings, outwardly projecting from the surface of the sidewall (12). The beads, (11) and (16), may be formed on one sidewall (12) or on both sidewalls. Between the two beads is a section of the sidewall (18). The color of the section of the sidewall (18) may contrast the colors of the said two beads (11) and (16).

The beads may have contrasting colors for instance, red, white, blue, yellow, etc. for rendering said beads obvious in different weather conditions to be faced by the tire, such as rain or snow

The two outwardly projecting annular beads, (11) and (16), and the intervening section of sidewall (18) may be viewed from many different and distinct angles and the visible orientation of the said beads thus observed will be one of three possible arrangements.

To use the invention described herein, the tire is best viewed from a vantage point above the lowest and most central position of the outwardly facing sidewall where said sidewall is adjacent to the road surface. A plurality of viewing angles and sightlines are possible revealing a plurality of visual arrangements of the said beads and said interstitial sidewall sections. Three distinct visible arrangements of the beads and intervening sidewall are possible:

If, viewing the arrangement of the two annular beads (11,16) in said manner discovers segments of said beads adjacent to the ground and virtually abutting one another as in sight line S1 of FIG. 2 then the tire may be considered adequately inflated. Conversely, if the virtual arrangement as illustrated in FIG. 2 can not be seen from any viewing position the tire is under-inflated.

From a vantage point as described above, a second arrangement of the beads and said sidewall may be observed, which discovers segments of the two said beads (11, 16), and a segment of the intervening section of sidewall (18), as illustrated in phantom in FIG. 2. This condition indicates that the tire is incorrectly, moderately under-inflated.

Also, a third arrangement of beads and the sidewall may be visible. From a vantage point as described above, the radially innermost bead (16) and the intervening section of sidewall (18) may visibly abut one another. However, the radially outermost bead (11) may not be visible at the extremity of the line of sight, because the intervening section of sidewall (18) has bulged outwardly and it obscures a section of the radially, outermost bead (11) adjacent to the road. Said arrangement indicates that the tire is extremely under-inflated.

If desired, the two concentric annular colored beads (11, 16) in FIG. 1 may be distinctly different shades of grey and white and visually distinct from the intervening segment of sidewall (18). The interstitial section of sidewall 18) may be a different and distinct color which contrasts the color of the raised beads (11, 16).

In FIG. 5, another embodiment of the tire provides a plurality of curvilinear, colored, outwardly projected bead segments (19,20) and an intervening section of sidewall (18) separating the said curvilinear beads.

Another embodiment of the tire provides two, concentric, annular, outwardly projected beads (11, 16) and each bead is a plurality of colors. Each arc of a colored bead contrasts the color of an arc of the other bead, which is located on the same radius from the center of the tire.

Another embodiment is equipped with said annular beads wherein the beads and interstitial sidewall are crosshatched so they contrast each other.

Another embodiment is equipped with said annular beads wherein the beads and interstitial sidewall are shaded so they contrast each other.

The said outwardly projecting beads may be added to the tire and affixed to the sidewall after the tire is manufactured.

What is claimed is:

1. A pneumatic vehicle tire comprising a pair of sidewalls and a ground engaging surface extending therebetween, at least one of said side walls having a first outwardly projecting annular bead positioned radially inwardly of a radius at which said at least one side wall maximally bulges and a second outwardly projecting annular bead positioned radially outwardly of said radius at which said tire maximally bulges.

2. The tire of claim 1 wherein said first bead and said second bead are concentric with a central axis of said tire.

3. The tire of claim 2 wherein said first bead has a contrasting colour to that of said second bead.

4. The tire of claim 2 wherein an annular band of said tire between said first bead and said second bead has a colour which contrasts with a colour of said first bead and a colour of said second bead.

5. The tire of claim 3 wherein an annular band of said tire between said first bead and said second bead has a colour which contrasts with a colour of said first bead and a colour of said second bead.

6. The tire of claim 1 wherein first bead is a continuous annular bead.

7. The tire of claim 6 wherein said second bead is a continuous annular bead.

8. The tire of claim 1 wherein said first bead is a discontinuous annular bead, comprising a plurality of bead segments.

9. The tire of claim 8 wherein said second bead is a discontinuous annular bead, comprising a plurality of bead segments.

10. The tire of claim 1 wherein different arcs of said first bead have different colours and different arcs of said second bead have different colours such that a given arc of said first bead that is radially aligned with a particular arc of said second bead has a different colour than said particular arc.

11. A method of determining proper inflation of a tire, comprising: sighting a portion of a first outwardly projecting annular bead of a sidewall of said tire closest to a portion of said tire which is engaging the ground, said first bead positioned radially inwardly of a radius at which said sidewall maximally bulges, at a plurality of angles in an effort to visually align said first bead with a second outwardly projecting annular bead of said sidewall positioned radially outwardly of said radius at which said sidewall maximally bulges; if said first and second annular beads cannot be visually aligned, determining said tire as incorrectly inflated.
